(19) United States
(12) Patent Application Publication
(10) Pub. No.: US 2025/0126004 A1
(43) Pub. Date: Apr. 17, 2025

(54) PROCEDURES AND SIGNAL DESIGN FOR NTN NB-IOT WUR

(71) Applicant: MEDIATEK INC., Hsinchu (TW)

(72) Inventors: Chien-Chun Cheng, Hsinchu (TW); Wei-De Wu, Hsinchu (TW); Yi-Ju Liao, Hsinchu (TW); Chun-Chia Chen, Hsinchu (TW)

(21) Appl. No.: 18/903,156

(22) Filed: Oct. 1, 2024

Related U.S. Application Data
(60) Provisional application No. 63/590,007, filed on Oct. 13, 2023.

(51) Int. Cl. H04L 27/26; H04L 27/32; H04W 52/02

(52) U.S. Cl. CPC H04L 27/26025; H04L 27/32; H04W 52/0229

(57) ABSTRACT

In an aspect of the disclosure, a method, a computer-readable medium, and an apparatus are provided. The apparatus may be a UE. The UE receiving a unified waveform signal from a base station, wherein the unified waveform signal comprises an On-Off Keying (OOK) signal and an Orthogonal Frequency Division Multiplexing (OFDM) signal; determining whether an indicator in the OFDM signal indicates that the unified waveform signal is a low-power wake-up signal (LP-WUS); decoding the LP-WUS when the indicator indicates that the unified waveform signal is the LP-WUS; and terminating a decoding operation when the indicator indicates that the unified waveform signal is not the LP-WUS.

### CROSS-REFERENCE TO RELATED APPLICATION(S)

This application claims the benefits of U.S. Provisional Application Ser. No. 63/590,007, entitled “PROCEDURES AND SIGNAL DESIGN FOR NTN NB-IoT WUR” and filed on Oct. 13, 2023, which is expressly incorporated by reference herein in their entirety.

### BACKGROUND

### Field

The present disclosure relates generally to communication systems, and more particularly, to using Narrow Band Internet of Thing (NB-IoT) as a Wake Up Receiver (WUR) for network energy saving with respect to user equipment (UE) and network apparatus in mobile communications.

### Background

The statements in this section merely provide background information related to the present disclosure and may not constitute prior art.

In 5th Generation Mobile Communication Technology (5G), User Equipment (UE) often needs to be awakened to monitor paging messages. In existing technologies, paging enhancement features are typically used to notify the UE before the paging occasion whether it should be awakened for monitoring. However, in specific scenarios such as Non-Terrestrial Network Narrow Band-Internet of Things (NTN NB-IoT), for devices lacking a continuous power source, high power consumption during wake-up periods currently affects battery life and latency. Therefore, it is necessary to develop communication methods that support ultra-low power mechanisms and lower latency to improve the longevity and efficiency of the device.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The UE receiving a unified waveform signal from a base station, wherein the unified waveform signal comprises an On-Off Keying (OOK) signal and an Orthogonal Frequency Division Multiplexing (OFDM) signal; determining whether an indicator in the OFDM signal indicates that the unified waveform signal is a low-power wake-up signal (LP-WUS); decoding the LP-WUS when the indicator indicates that the unified waveform signal is the LP-WUS; and terminating a decoding operation when the indicator indicates that the unified waveform signal is not the LP-WUS.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 is a diagram illustrating the functions of the UE.

FIG. 4 is a diagram illustrating the interaction process between a base station and the UE.

FIG. 5 is a diagram illustrating the monitoring occasion of the UE.

FIG. 6 is an illustration of the unified waveform signal sequence.

FIG. 7 is a flow chart of a method (process) for wireless communication of a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

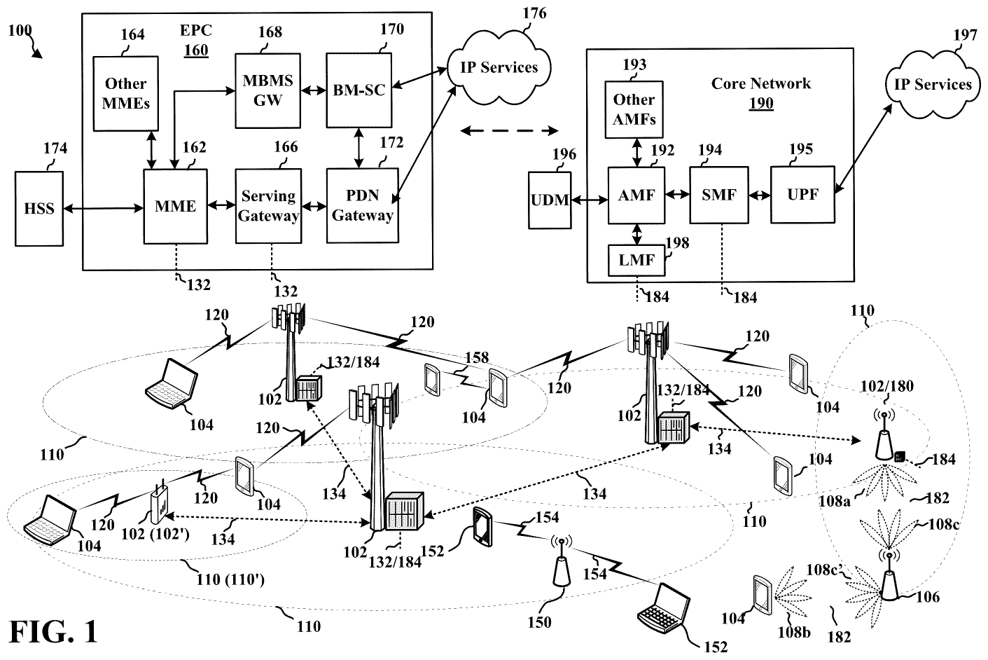

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

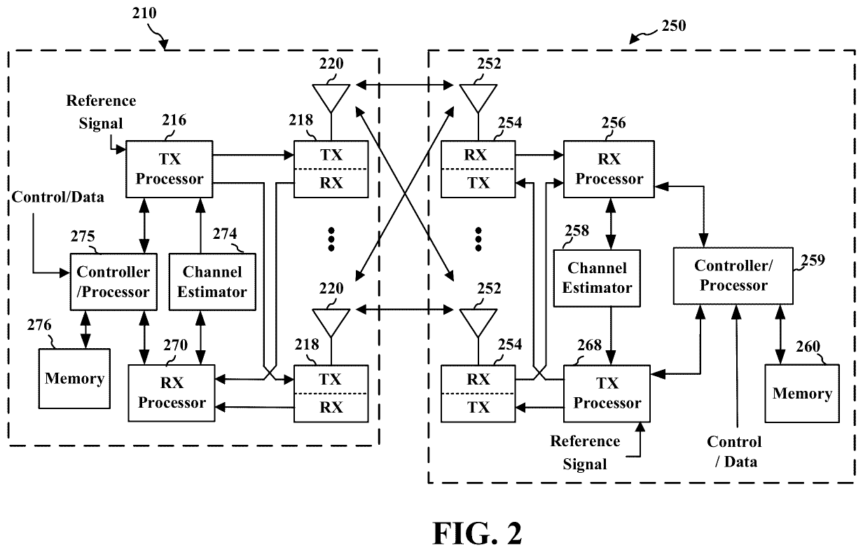

FIG. 2 is a block diagram 200 of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

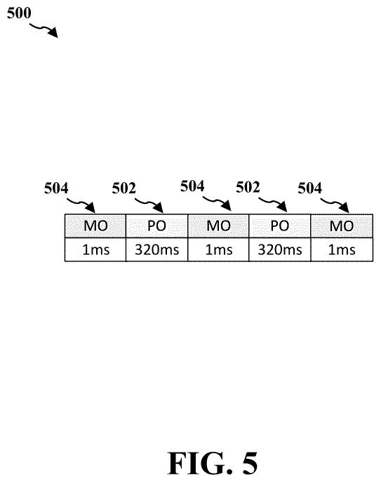

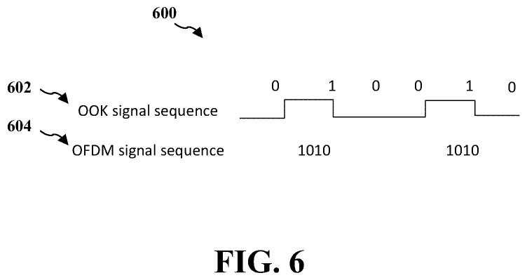

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases, DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

Evolved Packet System (EPS) includes the Evolved UMTS Terrestrial Radio Access Network (E-UTRAN) and the Evolved Packet Core (EPC). The EPC comprises the Mobility Management Entity (MME), Serving Gateway (SGW), and Packet Data Network Gateway (PGW). It is mainly responsible for mobility management, Non-Access Stratum (NAS) signaling processing, and EPS bearer resource control.

An EPS bearer is a logical pipe of one or more service data flows (SDFs) between the User Equipment (UE) and PGW. After the UE attaches to the core network, when initiating a data service, it obtains the required bearer resources for the service by initiating a bearer resource allocation procedure. Based on the QoS parameters and Traffic Flow Templates (TFTs) carried in the request message sent by the UE during the procedure, the EPC allocates bearer resources that match the current service.

In current networks, there are still frequent inter-RAT (Inter Radio Access Technology) tracking area update (TAU) processes that switch from GSM/EDGE Radio Access Network (GERAN) and Universal Terrestrial Radio Access Network (UTRAN) to LTE networks. Correspondingly, this may also lead to bearer modification processes triggered by UE's QoS changes after the inter-RAT TAU is completed. The modification process includes mobile originated (MO) modification in the uplink and mobile terminated (MT) modification in the downlink.

In addition, to ensure efficient use of resources, the base station may initiate a UE context release request to the core network for a UE in cases such as: 1) The base station determines that the UE has not sent any data transmission requests within a certain time; 2) The base station does not receive the initial context establishment request sent by the core network within a certain time; 3) The base station determines that it is unnecessary to configure resources for the UE; or 4) The base station is unable to provide resources to the UE due to its own faults. After receiving the UE context release command from the core network, the base station releases all resources configured for the UE.

In LTE, the UE can use the modification procedure to release bearer resources. To release the bearer resources, the UE includes all packet filters (PFs) belonging to the bearer. In the EPS bearer context modification procedure, if there are two or more packet filters among all TFTs associated with this PDN connection that have identical packet filter precedence values (if the old PF belongs to a dedicated EPS bearer context), a precedence conflict will occur. In this case, the UE needs to: 1) Delete the old PFs which have identical precedence values; and 2) Perform a UE requested bearer resource modification procedure to deactivate the corresponding dedicated EPS bearer context.

When the UE requested bearer resource modification procedure collides with the EPS bearer context modification procedure, the UE will abort the UE requested bearer resource modification procedure and enter the state BEARER CONTEXT ACTIVE.

However, if the purpose is to release the bearer, aborting the UE requested procedure and entering the state BEARER CONTEXT ACTIVE will keep the bearer alive, which does not align with the UE's intention. Moreover, if the corresponding dedicated EPS bearer has no PFs in its TFT, then such bearer cannot be maintained, and it is not possible to enter the state BEARER CONTEXT ACTIVE. There is a need to address these issues.

In Evolved Packet System (EPS) of wireless evolved networks, the core network mainly includes three logical function entities of MME, SGW, and PGW. Among them, MME is mainly responsible for NAS signaling encryption, assigning temporary identity marks for UE, selecting core network elements such as SGW and PGW, and providing roaming, tracking, security and other functions. In addition, when the UE is in idle state, MME can save bearer context information. PGW is the gateway that provides services for connections, responsible for forwarding and filtering UE data streams, etc. SGW is mainly responsible for relaying UE service streams between UE and PGW and serving as an anchor point during inter-base station handover.

Those skilled in the art understand that PDN connection is the logical data path between UE and PDN, while EPS bearer is a smaller logical data path contained in the PDN connection. The role of PDN connection is to ensure connectivity between UE and PDN, and to transmit SDF between UE and PDN, while the role of EPS bearer is to achieve more refined QoS control. EPS bearer is a type of bearer in LTE.

In wake-up receiver (WUR) systems, the design of the wake-up signal (WUS) directly impacts power efficiency, latency, and reliability. Two types of waveforms are considered for WUS: the orthogonal frequency-division multiplexing (OFDM)-based waveform and the on-off keying (OOK) waveform.

The OFDM-based waveform is a digital modulation technique extensively used in wireless communication systems like LTE, Wi-Fi, and DVB. It offers robustness against multipath fading and improves spectral efficiency. However, OFDM requires complex signal processing, leading to higher power consumption, which is undesirable in WUR systems where low power consumption is critical.

On the other hand, OOK is a simple form of amplitude-shift keying where binary data is represented by the presence (ON) or absence (OFF) of a carrier wave. It is well-suited for low-power and low-data-rate WUR systems due to its simplicity and minimal power requirements. However, OOK has limitations in spectral efficiency and data rate compared to OFDM.

In NB-IoT (Narrow-Band Internet of Things) communications, there is a need to create a unified waveform that combines the benefits of both OFDM (Orthogonal Frequency Division Multiplexing) and OOK (On-Off Keying) waveforms, balancing power efficiency, latency, and reliability.

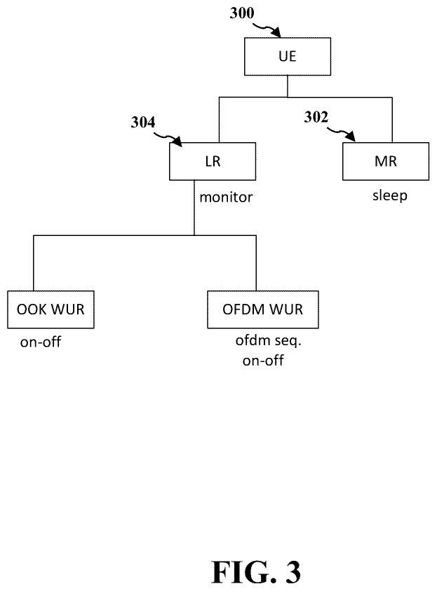

FIG. 3 illustrates a functional diagram of a user equipment (UE) 300 in a wireless communication system. The UE 300 is functionally divided into two primary modules: a Main Radio (MR) 302 and a Low Power Radio (LR) 304. The MR 302 is responsible for complex communication tasks and may be in a sleep mode to conserve power. The LR 304, on the other hand, continuously monitors for low-power wake-up signals (LP-WUS) transmitted by a base station.

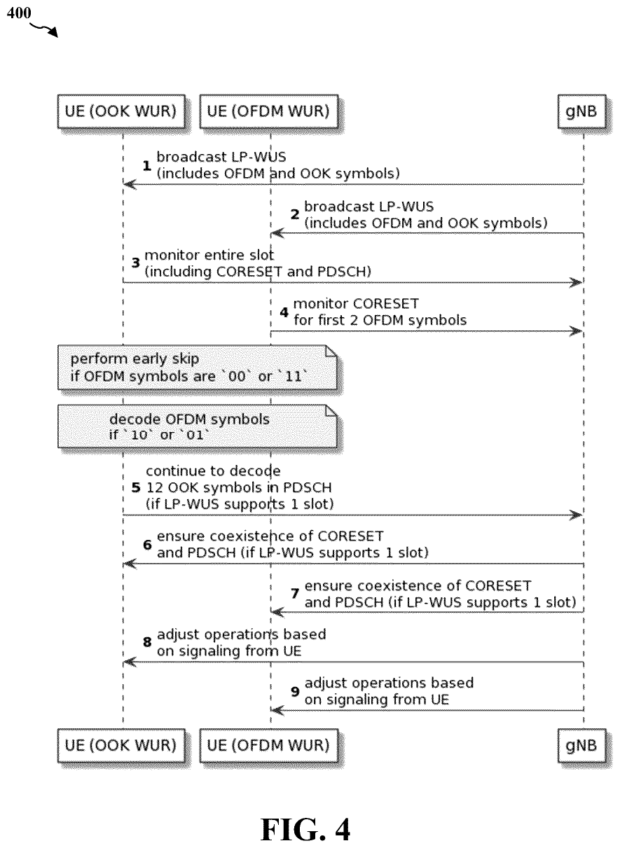

The LR 304 functions as a wake-up receiver (WUR). It remains active to monitor for low-power wake-up signals (LP-WUS) transmitted by a base station 402 (as shown in FIG. 4). The LR 304 is designed for low power consumption and has limited functionality compared to the MR 302. Its primary purpose is to detect LP-WUS and decide whether to wake up the MR 302 based on the received signals.

The UE 300 is designed to receive a unified waveform signal from a base station, such as a base station 402 shown in FIG. 4. This unified waveform signal incorporates both On-Off Keying (OOK) and Orthogonal Frequency Division Multiplexing (OFDM) components, allowing for a flexible and efficient wake-up mechanism.

The unified waveform design for LP-WUS typically comprises 2 OFDM symbols within a New Radio (NR) Control Resource Set (CORESET) that can span 1 to 3 OFDM symbols, followed by 12 OOK symbols within an NR Physical Downlink Shared Channel (PDSCH). The initial OFDM symbols serve as an indicator, with different patterns signifying various states:
1. ‘00’: No signal
2. ‘11’: Legacy signal
3. ‘10’ or ‘01’: LP-WUS (with ‘10’ typically used for payload and ‘01’ for preamble or LP-Secondary Synchronization Signal)

This design enables an early termination mechanism for both OOK-based and OFDM-based Wake-Up Receivers (WURs). When the initial OFDM symbols are ‘00’ or ‘11’, both types of WURs can perform an early skip, promptly terminating their operations to save power and processing time. Conversely, when the symbols are ‘10’ or ‘01’, indicating an LP-WUS, both WURs proceed to decode the symbols.

The LR 304 within the UE 300 employs different strategies for OFDM-based and OOK-based WURs when monitoring a single slot. The OFDM-based WUR focuses solely on monitoring the CORESET, while the OOK-based WUR monitors the entire slot.

The unified waveform design introduces the concepts of OOK-1 and OOK-4, which refer to the number of OOK ON or OFF states within a single OFDM symbol. OOK-1 represents one ON or OFF state per OFDM symbol, while OOK-4 allows for multiple OOK ON or OFF states within a single OFDM symbol.

In scenarios where the LP-WUS supports a single slot, the CORESET (up to 3 symbols) and PDSCH (11 symbols) can coexist. The CORESET is limited to supporting either OOK-1 or OFDM WUS. The interpretation of the symbols in this case is as follows:
‘00’ or ‘11’: Both WURs perform early skip
‘10’: Identified as OOK WUS
‘01’: Identified as OFDM WUS
   The PDSCH, in contrast, can support either OOK-1 or OOK-4, providing additional flexibility in signal design.

This unified design facilitates the coexistence of OFDM and OOK waveforms in LP-WUS, offering a mechanism for early skip to enhance power efficiency. The early skip feature is particularly beneficial for reducing unnecessary wake-ups and power consumption, especially for the OFDM-based WUR, which typically requires more power for signal processing.

The LP-WUS can carry various types of information, including a specific UE ID or a UE group ID. This allows the LR 304 to determine whether to wake up the MR 302 based on the decoded LP-WUS. If the LP-WUS does not indicate the relevant UE ID or group ID, the MR 302 can remain in sleep mode, further conserving power.

In practice, the unified waveform signal allows for flexible distribution of information bits between the OFDM and OOK signals. The information bits can be entirely or partially contained within the OFDM signal (represented as ‘1010’), or they can be distributed between the OFDM signal and the OOK signal pattern (represented as ‘010010’).

The system supports multiple options for carrying information. In one approach, the OFDM sequence in the OFDM signal is selected from multiple candidate sequences, each corresponding to an ON symbol of the OOK signal. The UE 300 can then extract part or all of the LP-WUS information from the selected OFDM sequence.

For instance, with an OOK signal ‘01001’ and candidate OFDM sequences ‘101’, ‘010’, ‘110’, if ‘101’ corresponds to the first ON symbol, the UE 300 can select this sequence when it receives a unified waveform signal where the ON symbol of the OOK signal is ‘1’. The UE 300 can then extract the LP-WUS information from this selected sequence.

In scenarios where the OFDM sequence contains only part of the LP-WUS information, the UE 300 can obtain all the information by combining the OFDM sequence data, its position, and the remaining OOK symbols.

FIG. 4 is a diagram 400 illustrating a unified waveform design for Low-Power Wake-Up Signal (LP-WUS) in a wireless communication system. The diagram depicts interactions between a base station 402, such as a gNB, and a user equipment (UE) 404. The UE 404 includes two types of wake-up receivers (WURs): an On-Off Keying (OOK)-based WUR and an Orthogonal Frequency Division Multiplexing (OFDM)-based WUR.

The base station 402 broadcasts the LP-WUS, which comprises two main components: the first 2 OFDM symbols located in the Control Resource Set (CORESET) and the subsequent 12 OOK symbols located in the Physical Downlink Shared Channel (PDSCH). This unified waveform design allows the coexistence of OFDM and OOK waveforms within a single LP-WUS, providing flexibility to serve different types of WURs.

In operation 1 and operation 2, the base station 402 broadcasts the LP-WUS, which includes the first 2 OFDM symbols located in the CORESET and the subsequent 12 OOK symbols located in the PDSCH. This unified waveform serves two different types of Wake-Up Receivers: one that reads the OFDM part and another that reads the On and Off parts.

The OOK part of the waveform can transmit a limited number of bits, for example, ‘010010’. To increase the information capacity, OFDM sequences are transmitted in the ‘ON’ parts of the OOK waveform. These OFDM sequences can carry more information bits, potentially four bits in this example, such as ‘1010’.

In operation 3, the OOK-based WUR in the UE 404 begins by monitoring the entire slot, which includes both the CORESET and PDSCH. If the first 2 OFDM symbols in the CORESET are ‘00’ or ‘11’, the WUR performs an early skip, recognizing there is no LP-WUS in the slot and terminating its operations early. This early termination feature is crucial for power saving in the WUR system. If the OFDM symbols are ‘10’ or ‘01’, indicating an LP-WUS, the OOK-based WUR decodes these symbols.

In operation 4, the OFDM-based WUR in the UE 404 begins by monitoring only the CORESET for the first 2 OFDM symbols of the LP-WUS. Similar to the OOK-based WUR, if the OFDM symbols are ‘00’ or ‘11’, the OFDM-based WUR performs an early skip. If the symbols are ‘10’ or ‘01’, indicating an LP-WUS, the OFDM-based WUR decodes these symbols.

The OFDM-based WUR can obtain additional information from the on-off pattern of the OOK symbols. This design allows the OFDM-based WUR to extract information not only from the OFDM sequence itself but also from the positioning of the OFDM symbols within the OOK pattern. This allows the OFDM-based WUR to extract additional information from the position of the ‘0’ and ‘1’ in the OOK pattern. For instance, a pattern of ‘010010’ in the OOK symbols could carry additional information beyond what is contained in the OFDM sequence alone.

In operation 5, if the LP-WUS supports a single slot, the OOK-based WUR continues to decode the subsequent 12 OOK symbols in the PDSCH. This extended decoding allows the OOK-based WUR to extract more information from the LP-WUS, potentially including UE group IDs or other relevant data.

Operations 6 and 7 illustrate that if the LP-WUS supports a single slot, the base station 402 ensures the coexistence of the CORESET and PDSCH within that slot. This coexistence is for the efficient use of resources and the proper functioning of both OOK-based and OFDM-based WURs.

In operations 8 and 9, the base station 402 adjusts its operations based on the signaling from the UE 404. These adjustments may include changes to the scheduling of the LP-WUS or modifications to the payload or preamble based on the UE's behavior.

This design also introduces the concept of early termination for power saving. By allowing WURs to identify non-LP-WUS transmissions early (through the ‘00’ or ‘11’ patterns), the system significantly reduces unnecessary wake-ups and power consumption. This is particularly beneficial for the OFDM-based WUR, which typically requires more power for signal processing.

The unified waveform supports various options for information carrying. In one approach, a single overlaid OFDM sequence is placed on each OOK ‘ON’ symbol. Alternatively, the OFDM sequence may carry part of the LP-WUS information, with the OFDM-based WUR obtaining the complete information by combining the OFDM sequence data with the location pattern of the OFDM/OOK symbols.

FIG. 5 is a diagram 500 illustrating the monitoring occasions (MOs) 504 and paging occasions (POs) 502 in relation to the low-power wake-up signal (LP-WUS) monitoring by the Low Power Radio (LR) 304 within the user equipment (UE) 300. The diagram depicts the time structure of MOs 504 and POs 502, highlighting how the LR 304 and the Main Radio (MR) 302 interact to achieve power-efficient operation while ensuring timely reception of paging messages from the base station 402.

In this system, the LR 304 is configured to monitor for the LP-WUS at specific MOs 504, which occur periodically. These MOs are scheduled at regular intervals, denoted as T_{MO}. For example, the MOs 504 may occur every T_{MO}=320 milliseconds. Each MO 504 has a duration, denoted as T_{MO_dur}, which may be approximately 1 millisecond. During each MO 504, the LR 304 becomes active to listen for the LP-WUS transmitted by the base station 402.

Within the T_{MO_dur}=1 millisecond duration of an MO 504, the LR 304 can determine whether the received signal is the LP-WUS intended for the UE 300. This determination is based on the initial two OFDM symbols in the CORESET of the unified waveform signal. These symbols act as indicators for the presence of the LP-WUS.

The initial two OFDM symbols can have one of the following configurations:
‘00’: Indicates no signal.
‘11’: Indicates a legacy signal.
‘10’ or ‘01’: Indicates the presence of an LP-WUS.

If the first two OFDM symbols are ‘00’ or ‘11’, the LR 304 recognizes that there is no LP-WUS intended for the UE 300 in the current slot. In such cases, the LR 304 can perform an early termination of monitoring, returning to sleep mode to conserve power. This early termination mechanism reduces unnecessary wake-up events and extends battery life.

If the first two OFDM symbols are ‘10’ or ‘01’, indicating the presence of an LP-WUS, the LR 304 continues to monitor and decodes these symbols. Depending on the type of wake-up receiver (WUR) implemented:

For an OOK-based WUR, the LR 304 continues to monitor the entire slot corresponding to the unified waveform signal. It decodes the initial OFDM symbols and the subsequent On-Off Keying (OOK) symbols in the Physical Downlink Shared Channel (PDSCH), acquiring all the necessary information bits, such as user equipment (UE) group identifiers (IDs).

For an OFDM-based WUR, the LR 304 primarily monitors only the CORESET, focusing on the initial two OFDM symbols. Upon detecting ‘10’ or ‘01’, the OFDM-based WUR decodes these symbols to extract the required information. If the initial symbols indicate no LP-WUS, it can perform early termination without monitoring further symbols.

Once the LR 304 has successfully decoded the LP-WUS and verified that it is intended for the UE 300 or its group, it proceeds to wake up the MR 302. The MR 302 then becomes active to monitor paging messages during the upcoming PO 502. The POs 502 are scheduled at intervals, often aligned with the MOs 504, allowing the UE 300 to receive paging messages transmitted by the base station 402 on the Physical Downlink Control Channel (PDCCH).

The MR 302 uses configuration information received prior to entering sleep mode to determine the specific POs 502 it needs to monitor. This pre-stored configuration includes parameters such as the paging cycle, paging frame offset, and system information necessary to locate and decode the paging messages efficiently.

In the idle mode operation, the primary function of the LP-WUS is to activate the MR 302 at the appropriate times to monitor for paging messages. The LP-WUS serves as a trigger, activating the MR 302 during the correct POs 502. This mechanism allows the MR 302 to remain in sleep mode when there are no paging messages intended for the UE 300, conserving power.

Since the OFDM-based WUR may require more power for signal processing compared to the OOK-based WUR, minimizing the active monitoring duration is beneficial for power efficiency. By determining the absence of an LP-WUS within the first two OFDM symbols, the OFDM-based WUR can promptly return to sleep mode if no LP-WUS is detected.

For example, consider an MO 504 occurring every 320 milliseconds, with a duration of 1 millisecond. Within this 1 millisecond, the OFDM-based WUR only needs to process the initial two OFDM symbols, which may occupy a fraction of the 1 millisecond slot. If these symbols indicate no LP-WUS, the WUR can immediately cease monitoring, significantly reducing power consumption.

Furthermore, the MR 302, before entering sleep mode, receives complete configuration information about its paging occasions. This includes knowing the exact POs 502 it needs to monitor upon waking. Therefore, when the LR 304 wakes up the MR 302 after detecting an LP-WUS, the MR 302 can quickly begin monitoring the PDCCH during the designated PO 502 without additional signaling or delay.

In some implementations, the LP-WUS may carry minimal information, such as a UE group ID. This is sufficient for the LR 304 to determine whether the MR 302 needs to be awakened. The MR 302 relies on pre-stored configurations to know when and where to monitor for paging messages.

The coordination between the LR 304 and MR 302, facilitated by the unified waveform design and structured monitoring occasions, enables the UE 300 to operate efficiently in terms of power consumption while maintaining responsiveness to network communications. Further, the LP-WUS mechanism may be extended to connected mode operations. In connected mode, the LP-WUS could trigger the MR 302 to monitor for control messages on the PDCCH, facilitating more efficient power management during active communications.

FIG. 6 illustrates a unified waveform signal sequence 600 for Low-Power Wake-Up Signal (LP-WUS) in a wireless communication system. The unified waveform signal comprises an On-Off Keying (OOK) signal sequence 602 and an Orthogonal Frequency Division Multiplexing (OFDM) signal sequence 604. The OOK signal sequence 602 is represented as ‘010010’, where ‘1’ indicates an ON symbol and ‘0’ represents an OFF symbol. The OFDM signal sequence 604, shown as ‘1010’, corresponds to the ON symbols of the OOK signal.

The unified waveform design allows for flexible distribution of information bits between the OFDM and OOK signals. The information bits can be entirely or partially contained within the OFDM signal, or they can be entirely or partially contained within the ON/OFF patterns of the OOK signal, or they can be distributed between the OFDM signal and the OOK signal. For example, a portion of the information bits may be transmitted through the OFDM signal, while the remaining bits are conveyed through the OOK signal pattern.

In one scenario, if the OFDM sequence in the OFDM signal does not contain the information bits of the LP-WUS, it indicates that the information bits are fully contained in the OOK signal. In this case, a user equipment (UE) 404 can obtain all the information bits by decoding the ON/OFF pattern of the OOK signal.

The system supports multiple options for carrying information. In one approach, the OFDM sequence in the OFDM signal is selected from multiple candidate OFDM sequences. Each candidate OFDM sequence may correspond to an ON symbol of the OOK signal, or it may consist of consecutive OFDM symbols. The UE 404 can then obtain part or all of the information bits from the LP-WUS through the OFDM sequence and subsequently recover the actual transmitted data by decoding these information bits.

For instance, consider an OOK signal ‘01001’ and multiple candidate OFDM sequences: ‘101’, ‘010’, ‘110’. If the candidate OFDM sequence ‘101’ corresponds to the first ON symbol of the OOK signal, and the UE 404 receives a unified waveform signal where the ON symbol of the OOK signal is ‘1’, then it can select the candidate OFDM sequence ‘101’ as the OFDM sequence in the OFDM signal. The UE 404 can then extract part or all of the information bits of the LP-WUS from this selected OFDM sequence.

In scenarios where the OFDM sequence corresponds to an ON symbol of the OOK signal but only contains part of the information bits of the LP-WUS, the UE 404 can obtain all the information bits through a combination of the OFDM sequence, the position of the OFDM sequence, and the remaining OOK symbols. For example, with an OOK signal ‘01001’, if the OFDM sequence ‘101’ corresponds to the first ON symbol and carries only part of the information bits (e.g., ‘1’), the UE 404 can recover the complete information bits of the LP-WUS by considering the position of the OFDM sequence (first position in this case) and the remaining OOK symbols (‘001’).

When the OFDM sequence corresponding to an ON symbol of the OOK signal contains all the information bits of the LP-WUS, the UE 404 can directly obtain all the information bits from the OFDM sequence alone. For instance, if the OFDM sequence ‘101’ corresponds to the first ON symbol of the OOK signal ‘01001’ and carries all the information bits (e.g., ‘10’), the UE 404 can directly extract the complete information bits of the LP-WUS from this OFDM sequence.

The system also supports scenarios where each candidate OFDM sequence corresponds to one or more ON symbols of the OOK signal. For example, with an OOK signal ‘01100’ and candidate OFDM sequences ‘101’, ‘010’, ‘110’, each ON symbol can correspond to one or more OFDM symbols. In this case, a single ‘1’ might correspond to ‘101’, while two consecutives ‘1’s might correspond to ‘101 101’. The UE 404 can then obtain part or all of the information bits of the LP-WUS through these selected OFDM sequences.

This unified waveform allows for early termination, a feature that enables both OOK-based and OFDM-based Wake-Up Receivers (WURs) in the UE 404 to identify non-LP-WUS transmissions early (through ‘00’ or ‘11’ patterns in the first two OFDM symbols) and terminate their operations, thus saving power and processing time.

This design supports different behaviors for OFDM WUR and OOK WUR within a single slot. The OFDM WUR monitors only the Control Resource Set (CORESET), while the OOK WUR monitors the complete slot. This design allows for the coexistence of OFDM and OOK waveforms in LP-WUS, providing a mechanism for early skip to enhance power efficiency.

Furthermore, the system introduces the concepts of OOK-1 and OOK-4, referring to the number of OOK ON or OFF states within a single OFDM symbol. OOK-1 has one ON or OFF state within an OFDM symbol, while OOK-4 allows for multiple OOK ON or OFF states within an OFDM symbol. This provides more flexibility and potentially higher data rates, albeit with increased receiver design complexity.

In scenarios where LP-WUS supports one slot, the CORESET (up to 3 symbols) and Physical Downlink Shared Channel (PDSCH) (11 symbols) can coexist. The CORESET can support either OOK-1 or OFDM WUS. If the symbols are ‘00’ or ‘11’, both WURs can perform early skip. If the symbols are ‘10’ or ‘01’, they are identified as OOK WUS and OFDM WUS respectively. The PDSCH can support either OOK-1 or OOK-4.

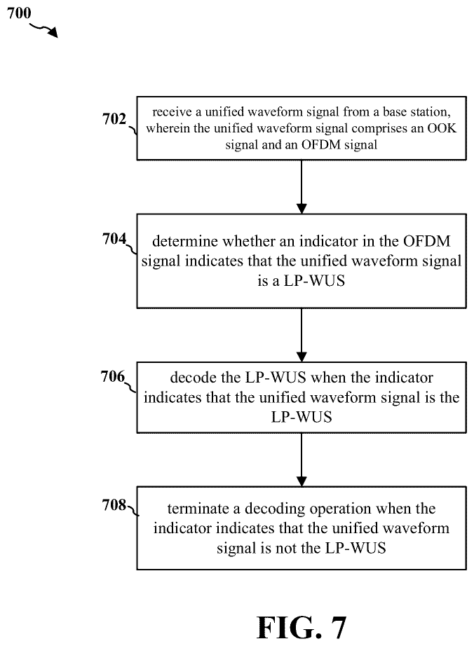

FIG. 7 is a flow chart 700 of a method for wireless communication of a user equipment (UE). The method may be performed by a UE 300. In operation 702, the UE receives a unified waveform signal from a base station, wherein the unified waveform signal comprises an On-Off Keying (OOK) signal and an Orthogonal Frequency Division Multiplexing (OFDM) signal.

In operation 704, the UE determines whether an indicator in the OFDM signal indicates that the unified waveform signal is a low-power wake-up signal (LP-WUS). In operation 706, the UE decodes the LP-WUS when the indicator indicates that the unified waveform signal is the LP-WUS. In operation 708, the UE terminates a decoding operation when the indicator indicates that the unified waveform signal is not the LP-WUS.

In certain configurations, an OFDM sequence in the OFDM signal corresponds to an ON symbol of the OOK signal. To decode the LP-WUS, the UE further obtains all information bits through the OFDM sequence.

In certain configurations, an OFDM sequence in the OFDM signal does not contain information bits of the LP-WUS. To decode the LP-WUS, the UE further obtains all information bits through an ON/OFF pattern of the OOK signal.

In certain configurations, an OFDM sequence in the OFDM signal is determined from multiple candidate OFDM sequences, wherein each candidate OFDM sequence corresponds to an ON symbol of the OOK signal or each candidate OFDM sequence has consecutive OFDM symbols. To decode the LP-WUS, the UE further obtains part or all of information bits of the LP-WUS through the OFDM sequence.

In certain configurations, the OFDM sequence corresponds to an ON symbol of the OOK signal and contains part of the information bits of the LP-WUS. To decode the LP-WUS, the UE further obtains all information bits through the OFDM sequence, a position of the OFDM sequence, and OOK symbols.

In certain configurations, the OFDM sequence corresponds to an ON symbol of the OOK signal and contains all information bits of the LP-WUS. To decode the LP-WUS, the UE further obtains all information bits through the OFDM sequence.

In certain configurations, an OFDM sequence in the OFDM signal is determined from multiple candidate OFDM sequences, wherein each candidate OFDM sequence corresponds to one or more ON symbols of the OOK signal. To decode the LP-WUS, the UE further obtains part or all of information bits of the LP-WUS through the OFDM sequence.

In certain configurations, the UE monitors first two OFDM symbols in a control resource set (CORESET) of the OFDM signal, wherein the first two OFDM symbols are configured as the indicator. In operation 712, the UE decodes the first two OFDM symbols when the first two OFDM symbols indicate that the unified waveform signal is the LP-WUS.

In certain configurations, the UE monitors an entire slot corresponding to the unified waveform signal. In operation 716, the UE decodes symbols of the OFDM signal and symbols of the OOK signal when first two OFDM symbols in a control resource set indicate that the unified waveform signal is the LP-WUS.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving a unified waveform signal from a base station, wherein the unified waveform signal comprises an On-Off Keying (OOK) signal and an Orthogonal Frequency Division Multiplexing (OFDM) signal;
determining whether an indicator in the OFDM signal indicates that the unified waveform signal is a low-power wake-up signal (LP-WUS);
decoding the LP-WUS when the indicator indicates that the unified waveform signal is the LP-WUS; and
terminating a decoding operation when the indicator indicates that the unified waveform signal is not the LP-WUS.

2. The method of claim 1, wherein an OFDM sequence in the OFDM signal corresponds to an ON symbol of the OOK signal,
wherein the method further comprises obtaining all information bits through the OFDM sequence.

3. The method of claim 1, wherein an OFDM sequence in the OFDM signal does not contain information bits of the LP-WUS, wherein the method further comprises obtaining all information bits through an ON/OFF pattern of the OOK signal.

4. The method of claim 1, wherein an OFDM sequence in the OFDM signal is determined from multiple candidate OFDM sequences, wherein each candidate OFDM sequence corresponds to an ON symbol of the OOK signal or each candidate OFDM sequence has consecutive OFDM symbols,
wherein the method further comprises obtaining part or all of information bits of the LP-WUS through the OFDM sequence.

5. The method of claim 4, wherein the OFDM sequence corresponds to an ON symbol of the OOK signal and contains part of the information bits of the LP-WUS,
wherein the method further comprises obtaining all information bits through the OFDM sequence, a position of the OFDM sequence, and OOK symbols.

6. The method of claim 4, wherein the OFDM sequence corresponds to an ON symbol of the OOK signal and contains all information bits of the LP-WUS,
wherein the method further comprises obtaining all information bits through the OFDM sequence.

7. The method of claim 1, wherein an OFDM sequence in the OFDM signal is determined from multiple candidate OFDM sequences, wherein each candidate OFDM sequence corresponds to one or more ON symbols of the OOK signal,
wherein the method further comprises obtaining part or all of information bits of the LP-WUS through the OFDM sequence.

8. The method of claim 1, further comprising:
monitoring first two OFDM symbols in a control resource set (CORESET) of the OFDM signal, wherein the first two OFDM symbols are configured as the indicator; and
decoding the first two OFDM symbols when the first two OFDM symbols indicate that the unified waveform signal is the LP-WUS.

9. The method of claim 1, further comprising:
monitoring an entire slot corresponding to the unified waveform signal; and
decoding symbols of the OFDM signal and symbols of the OOK signal when first two OFDM symbols in a control resource set indicate that the unified waveform signal is the LP-WUS.

10. An apparatus for wireless communication, the apparatus being a user equipment (UE), comprising:
a memory; and
at least one processor coupled to the memory and configured to:
receiving a unified waveform signal from a base station, wherein the unified waveform signal comprises an On-Off Keying (OOK) signal and an Orthogonal Frequency Division Multiplexing (OFDM) signal;
determining whether an indicator in the OFDM signal indicates that the unified waveform signal is a low-power wake-up signal (LP-WUS);
decoding the LP-WUS when the indicator indicates that the unified waveform signal is the LP-WUS; and
terminating a decoding operation when the indicator indicates that the unified waveform signal is not the LP-WUS.

11. The apparatus of claim 10, wherein an OFDM sequence in the OFDM signal corresponds to an ON symbol of the OOK signal, wherein the at least one processor is configured to obtaining all information bits through the OFDM sequence.

12. The apparatus of claim 10, wherein an OFDM sequence in the OFDM signal does not contain information bits of the LP-WUS, wherein the at least one processor is configured to obtaining all information bits through an ON/OFF pattern of the OOK signal.

13. The apparatus of claim 10, wherein an OFDM sequence in the OFDM signal is determined from multiple candidate OFDM sequences, wherein each candidate OFDM sequence corresponds to an ON symbol of the OOK signal or each candidate OFDM sequence has consecutive OFDM symbols, wherein the at least one processor is configured to obtaining part or all of information bits of the LP-WUS through the OFDM sequence.

14. The apparatus of claim 13, wherein the OFDM sequence corresponds to an ON symbol of the OOK signal and contains part of the information bits of the LP-WUS, wherein the at least one processor is configured to obtaining all information bits through the OFDM sequence, a position of the OFDM sequence, and OOK symbols.

15. The apparatus of claim 13, wherein the OFDM sequence corresponds to an ON symbol of the OOK signal and contains all information bits of the LP-WUS, wherein the at least one processor is configured to obtaining all information bits through the OFDM sequence.

16. The apparatus of claim 10, wherein an OFDM sequence in the OFDM signal is determined from multiple candidate OFDM sequences, wherein each candidate OFDM sequence corresponds to one or more ON symbols of the OOK signal, wherein the at least one processor is configured to obtaining part or all of information bits of the LP-WUS through the OFDM sequence.

17. The apparatus of claim 10, wherein the at least one processor is further configured to monitoring an entire slot corresponding to the unified waveform signal; and
decoding symbols of the OFDM signal and symbols of the OOK signal when first two OFDM symbols in a control resource set indicate that the unified waveform signal is the LP-WUS.

18. A computer-readable medium storing computer executable code for wireless communication of a user equipment (UE), comprising code to:
receiving a unified waveform signal from a base station, wherein the unified waveform signal comprises an On-Off Keying (OOK) signal and an Orthogonal Frequency Division Multiplexing (OFDM) signal;
determining whether an indicator in the OFDM signal indicates that the unified waveform signal is a low-power wake-up signal (LP-WUS);
decoding the LP-WUS when the indicator indicates that the unified waveform signal is the LP-WUS; and
terminating a decoding operation when the indicator indicates that the unified waveform signal is not the LP-WUS.

19. The computer-readable medium of claim 18, wherein an OFDM sequence in the OFDM signal corresponds to an ON symbol of the OOK signal, wherein the at least one processor is configured to obtaining all information bits through the OFDM sequence.

20. The computer-readable medium of claim 10, wherein an OFDM sequence in the OFDM signal does not contain information bits of the LP-WUS, wherein the at least one processor is configured to obtaining all information bits through an ON/OFF pattern of the OOK signal.
